(19) United States
(12) Patent Application Publication
(10) Pub. No.: US 2022/0080684 A1
(43) Pub. Date: Mar. 17, 2022

(54) METHOD FOR CLEANING AND POST PROCESSING 3D PRINTED LIGHT CURE SILICONES

(71) Applicant: Henkel AG & Co. KGaA, Duesseldorf (DE)

(72) Inventors: Michael Paul Levandoski, Terryville, CT (US); AiFu Che, Shanghai (CN); Jenny Jian Yi Cheng, Shanghai (CN); Jessica Bo Xu, Shanghai (CN)

(21) Appl. No.: 17/455,991

(22) Filed: Nov. 22, 2021

Related U.S. Application Data
(63) Continuation of application No. PCT/CN2019/087921, filed on May 22, 2019.

(51) Int. Cl. B29C 71/04; B33Y 40/20; B29C 64/35; B29C 64/124; B29C 71/00

(52) U.S. Cl. CPC B29C 71/04; B33Y 40/20; B33Y 80/00; B29C 64/124; B29C 71/0009; B29C 64/35

(57) ABSTRACT

The present invention is directed to a method for post processing a 3D printed part, to a three-dimensional part fabricated in a method according to the present invention, and further to the use of a liquid in the post processing of a three-dimensional part fabricated in a 3D printing method.

The present invention is directed to a method for post processing a 3D printed part, to a three-dimensional part fabricated in a method according to the present invention, and further to the use of a liquid in the post processing of a three-dimensional part fabricated in a 3D printing method.

Additive and subtractive manufacturing technologies, also referred to as solid freeform fabrication (“SFF”) techniques, enable computer designs, such as CAD files, to be made into three-dimensional (3D) objects. 3D printing, further known as additive manufacturing, typically comprises depositing, curing, fusing, or otherwise forming a material into sequential cross-sectional layers of the 3D part. Stereolithography, for instance, uses digital representations of the part to be made to additively form the three-dimensional part, wherein each additive photopolymer resin layer is cured by exposure to photo-radiation. Whereas in laser-based stereolithography (SLA), a laser is rapidly moved along the x- and y-axis across the print area to solidify the material along given coordinates, digital light processing (DLP) relies on the use of a digital projector screen that flashes a single image of each layer across the entire print area.

Parts formed by SFF techniques, particularly stereolithography, typically need to be cleaned during the manufacturing process to remove excess, unpolymerized resin. In particular, cleaning solvents often are used to strip away and dissolve excess resin to avoid distortion or damaging of the part that otherwise may occur in the course of manual cleaning.

Prior attempts to clean parts formed by stereolithography techniques have used alcohol as the cleaning solvent. Exposure to alcohol, however, can cause non-trivial swelling distortion of the stereolithography-formed part. This distortion affects the ability to accurately generate stereolithography-formed parts. Additional problems posed by post cleaning solvents, such as alcohols, include their toxicity, flammability, and volatility.

There is a need, therefore, for a method of cleaning stereolithography-formed parts that is effective in stripping excess resin but does not cause distortion of the part. Further, there is a need for a method that involves employment of a safe cleaning solvent that has low toxicity, is non-flammable and less volatile than commonly employed solvents.

This need is met by the object of the present invention, as provided herein is a method for the post processing of a 3D part using, as a cleaning solvent, a liquid that is incompatible, as herein defined, with the material the three-dimensional part is formed from, and exposing said 3D part immersed therein to ultrasound. With the method according to the present invention, fast as well as thorough, safe, economic, and ecologically sustainable post-processing of 3D printed parts is possible, wherein the solvent used not only removes excess resin, but at the same time ensures dimensional stability as well as oxygen elimination, thereby facilitating surface cure of the part.

In one aspect, the present invention thus relates to a method for post processing a 3D printed part, the method comprising:

A. providing a 3D printed part;

B. immersing said part into a first liquid medium that is incompatible with the material said part is printed from, and

C. exposing said part to ultrasound.

In another aspect, the present invention relates to a three-dimensional part obtainable in a method as described herein.

In yet another aspect, the present invention relates to the use of a liquid in the post processing of a three-dimensional part fabricated in a 3D printing method, wherein the liquid is incompatible with the material the three-dimensional part is printed from.

Embodiments of the present invention are described below, but the present invention is not limited thereto. It should be recognized that these embodiments are merely illustrative of the principles of the present invention. Numerous modifications and adaptations will be readily apparent to those of skill in the art without departing from the scope of the invention.

“One or more”, as used herein, relates to at least one and comprises 1, 2, 3, 4, 5, 6, 7, 8, 9 or more of the referenced species. Similarly, “at least one” means one or more, i.e. 1, 2, 3, 4, 5, 6, 7, 8, 9 or more. “At least one”, as used herein in relation to any component, refers to the number of chemically different molecules, i.e. to the number of different types of the referenced species, but not to the total number of molecules.

In the present specification, the terms “a” and “an” and “at least one” are the same as the term “one or more” and can be employed interchangeably.

“About”, as used herein in relation to a numerical value, means said value ±10%, preferably ±5%.

All percentages given herein in relation to the compositions or formulations relate to weight % relative to the total weight of the respective composition or formula, if not explicitly stated otherwise.

The terms “3D (three dimensional) printer”, “three-dimensional printing system,” 3D-printing”, “printing,” and the like generally describe various solid freeform fabrication techniques for making three-dimensional (3D) articles, objects or parts, herein used interchangeably, by selective deposition, jetting, fused deposition modeling, and other techniques now known in the art or that maybe known in the future that use a build material or print material to fabricate the three-dimensional object. In particular, the present invention refers to 3D parts formed by stereolithography techniques, such SLA and/or DLP.

The term “liquid”, as used herein, refers to compounds or mixtures of compounds that are flowable and pourable at room temperature (in the context of the present invention: about 8° C. to about 28° C., for instance about 20° C. to about 25° C.).

As understood by one of ordinary skill in the art and as described further herein, stereolithography techniques involve the consecutive solidifying of single layers of photopolymer resin, either right-side-up or bottom-up, with the first layer being in contact with a build platform or build surface.

In some embodiments, production of a 3D part may include the use of a support material in conjunction with the print material. The support material can be used to support at least one layer of the print material and can be used to form a variety of support structures, such as one or more fine points or a “raft.” A raft, in some embodiments, can be essentially planar and can form a lower portion of a support structure in contact with the build platform, such that the raft is disposed between the built platform and the print material of the 3D article. However, unlike the print material, the support material is subsequently removed to provide the finished three-dimensional part. In some embodiments, the support material comprises the same material or has the same chemical composition as the print material. In other instances, the support material has a different chemical composition than the print material. In other embodiments, a three-dimensional part fabricated in a 3D printing method does not comprise a support material/structure.

The methods and uses of the present invention are directed to cleaning parts formed by SFF (solid freeform fabrication) techniques, in particular by stereolithography techniques, such as SLA (stereolithography) and DLP (digital light processing). Stereolithography techniques, including radiation-curable stereolithographic compositions, are described in detail for example in U.S. Pat. Nos. 6,540,045, 6,533,062, 6,413,697, and 6,136,497, as well as U.S. Patent Application Publication No. 2007/0116311 A1, and International Patent Application No. 2008033296 A1.

In particularly, a stereolithography-formed part may be provided and post processed according to a method as herein described, wherein damaging, distortion and swelling of the part may be prevented.

The post processing method, as herein disclosed, comprises the following steps:

In step A) of the method according to the present invention, a 3D part is provided. In the context of the present invention, the term “3D printed part” relates to any three-dimensional object fabricated by a solid freeform fabrication technique. Particularly, the aforementioned term relates to any three-dimensional object fabricated by a stereolithography technique, particularly by a laser-based stereolithography (SLA) or digital light processing (DLP) technique, or a combination of the aforementioned. Thus, according to some embodiments, a 3D printed part provided in step A) of the present invention may be fabricated by a stereolithography technique, in particular by an SLA and/or a DLP technique.

According to certain embodiments, the material the 3D part is formed from is a stereolithography composition. Stereolithographic compositions are known in the art, as indicated above, and generally comprise photo-curable monomers and/or oligomers, photoinitiators, and optionally one or more additives, such as stabilizers, inhibitors, chelating agents, antioxidants, thickeners, plasticizers, fillers, dispersion stabilizers, hindered amine light stabilizers, and UV absorbers.

According to certain embodiments, the material the 3D printed part is fabricated from is a radiation-curable silicone composition. According to certain embodiments, the material the 3D printed part is fabricated from is a light-curable silicone composition. Exemplary light-curable compositions may be based on (meth)acrylates and/or silicones and may further comprise one or more photoinitiators as well as other components known in the art for the employment in such compositions,

According to certain embodiments, the radiation-curable silicone composition may further include one or more additives selected from the group consisting of stabilizers, inhibitors, chelating agents, antioxidants, thickeners, plasticizers, fillers, dispersion stabilizers, hindered amine light stabilizers, UV absorbers, opacifiers, pigments, and dyes.

In step B) of the method according to the present invention, the thus provided 3D part is immersed in a first liquid medium that is incompatible with the material the 3D printed part is formed from. In the context of the present invention, the term “incompatible” refers to a material incompatibility, which resides in a chemical inertness of the resin material of the part towards the liquid medium. In other words, upon contact of the liquid medium with the resin material, no chemical reaction occurs. Accordingly, the liquid neither dissolves nor is dissolved in the polymer matrix of the 3D part. Furthermore, there is little or no diffusion of molecules across the interface of liquid medium and polymerized resin material, nor strong absorption of molecules from one phase to the other, i.e. liquid phase of the liquid medium and solid phase of the polymerized resin material. Thereby, distortion and swelling of the part is prevented.

According to certain embodiments, the liquid medium is in the form of a composition, comprising two or more compounds. According to other embodiments, the liquid medium contains only one liquid compound. For instance, a liquid medium in the context of the present invention may be comprised of only one substance or of two or more substances, and may or may not contain additional ingredients such, for instance, salts and surfactants, so long as the liquid medium fulfills the criterion of incompatibility with the material the 3D printed part is formed from, as herein defined.

According to certain embodiments, the liquid medium is selected from the group consisting of water and demineralized water. Alternatively or additionally, any water-based cleaning solution may be used for the purposes of the present invention. Cleaning solutions suitable for employment in a method according to the present invention may comprise one or more components selected from surfactants, organic and inorganic acids, organic and inorganic bases, enzymes, and emulsifiers. Additional ingredients suitable for employment in water-based cleaning solutions that may be used in the cleaning of 3D printed parts are known in the art.

According to certain embodiments, the 3D printed part is immersed partially in the liquid medium. In certain other embodiments, the 3D printed part is submerged completely in the liquid medium. As, according to the present invention, the liquid medium is incompatible with the material the printed part is formed from, in step B), the immersion period is not particularly restricted. According to some embodiments, the part may be immersed for a period of about 1 second to about 24 hours, preferably for a period of about 30 seconds to about 12 hours, more preferably for a period of about 1 minute to about 6 hours, still more preferably for a period of 1 minute to about 60 minutes. For instance, the part may be immersed for a period of about 1 second, 5 seconds, 10 seconds, 30 seconds, 60 seconds, 2 minutes, 3 minutes, 5 minutes, 10 minutes, 20 minutes, 30 minutes, 60 minutes, 2 hours, 3 hours, 5 hours, 10 hours, 12 hours, or 24 hours.

According to some embodiments, the 3D printed part may be immersed while still attached to the build platform and/or supporting structure(s). According to other embodiments, the 3D printed part is immersed after detachment from the build platform and/or supporting structure(s). By partially or completely immersing the 3D printed part in the liquid medium, as herein described, dimensional support is provided to the part, thereby preventing or at least minimizing dimensional deformation of the part.

Furthermore, immersing of the 3D printed part in the liquid medium, as described herein, serves the purpose of removing excess, unpolymerized resin from the surface of the printed part. Since the liquid medium is incompatible with the resin material used for fabrication of the part, unreacted, i.e. unsolidified resin material may be emulsified into the liquid medium. According to some embodiments, removal of excess resin may be promoted and facilitated by agitation, for instance by agitating the liquid medium, for instance by means of a stirring device and/or a laboratory shaker.

Optionally, the method according to the present invention may additionally comprise a step A1) of removing excess unpolymerized resin material by one or more of drip drying, manual cleaning, and application of air pressure so as to further improve the entire cleaning procedure. “Drip drying”, as referred to herein, refers to any method of gravity assisted flow-off of excess resin from the surface of the printed part. “Manual cleaning”, as referred to herein, refers to any method involving manual removal of excess resin off the surface of the printed part, for instance by use of a fabric, towel, cotton swab, spatula, and the like.

In step C) of the method disclosed herein, the 3D part immersed in the liquid medium, as described herein, is exposed to ultrasound. By exposing the immersed part to ultrasound, excess, unpolymerized resin is removed from the surface of the printed part and emulsified into the liquid medium.

According to certain embodiments, step C) is conducted over a period of about 1 second to about 5hours, preferably over of about 30 seconds to about 60 minutes, more preferably of about 5 minutes to about 45 minutes. Thus, for instance, step C) may be conducted over a period of about 1 second,5 seconds, 10 seconds, 30 seconds, 60 seconds, 2 minutes, 3 minutes, 5 minutes, 10 minutes, 20 minutes, 30 minutes, 60 minutes, 2 hours, 3 hours, or 5 hours.

According to certain embodiments, ultrasound is applied at frequencies of about 15 kHz to about 40kHz, preferably of about 20 kHz to about 40 kHz. For instance, ultrasound may be applied at frequencies of about 15 kHz, 16 kHz, 17 kHz, 18 kHz, 19 kHz, 20 kHz, 25 kHz, 30 kHz, 35 kHz, or 40 kHz.

According to certain embodiments, step B) and/or step C) may be repeated one or more times. Naturally, for better results, a fresh, that is, unused liquid medium may be provided each time. The formulation of the liquid medium used for conducting steps B) and/or C) repeatedly may be the same formulation as used in original step B) and C), or may be different.

The post processing of a 3D printed part, as defined herein, may, according to certain embodiments of the present invention, further comprise a step D) of immersing the 3D printed part obtained after step C) into a second liquid medium that is incompatible with the material said part is formed from, and exposing said part to radiation. After material-sparing removal of excess resin according to the herein described method, exposure of the cleaned part to radiation finalizes the polymerization process and stabilizes the mechanical properties of the part. By immersing the part completely, oxygen inhibition may be prevented, which otherwise occurs in the presence of oxygen, for instance airborne oxygen in the case of air exposed surfaces, resulting in an incomplete cure. Furthermore, complete immersion of the printed part again helps maintaining dimensional stability during post-curing.

The second liquid medium of step D) may be of the same formulation as the liquid medium used in the one or more steps B) and C), or of a different formulation.

According to certain embodiments, radiation, in step D), refers to electromagnetic radiation. According to certain embodiments, radiation, in step D), refers to ultraviolet radiation, visible light or infrared radiation. In some embodiments, the printed part, in step D), is exposed to radiation with wavelengths in the range of about 10 nm to about 1 mm, preferably in the range of about 10 nm to about 800 nm, more preferably in the range of about 10 nm to about 700 nm. For instance, the printed part may be exposed to radiation with wavelengths of about 10 nm, 11 nm, 12 nm, 13 nm, 14 nm, 15 nm, 20 nm, 25 nm, 30 nm, 50 nm, 100 nm, 200 nm, 300 nm, 500 nm, 550 nm, 600 nm, 650 nm, 700 nm, 750 nm, 800 nm, 1 μm, 2 μm, 3 μm, 4 μm, 5 μm, 10 μm, 20 μm, 50 μm, 100 μm, 500 μm, or 1000 μm. In the context of the present invention, the source of radiation may be natural or artificial. For instance, the radiation may be sunlight or emitted by an UV and/or visible light LED.

Post-curing of the 3D printed part, as described herein, may be conducted over a period of about 1 second to about 24 hours, preferably of about 1 minute to about 12 hours, more preferably of about30 minutes to about 6 hours. For instance, step D) may be carried out for a duration of about 1 second, 2 seconds, 3 seconds, 5 seconds, 10 seconds, 30 seconds, 60 seconds, 2 minutes, 3 minutes, 5 minutes, 10 minutes, 20 minutes, 30 minutes, 60 minutes, 2 hours, 3 hours, 4 hours, 5 hours, 6 hours, 10 hours, 12 hours, 24 hours.

After completion of step D), the thus obtained part may be retrieved from the liquid medium, and optionally air dried, wiped dry, and/or dried by application of air pressure or exposure to heat.

In another aspect, the present invention further relates to the use of a liquid in the post processing of a three-dimensional part fabricated in a 3D printing method, wherein the liquid is incompatible with the material the three-dimensional part is printed from, as defined herein.

Thus, in accordance with the method described above, in certain embodiments, the 3D printing method is a stereolithography technique. According to some embodiments, the 3D printing method is an SLA and/or a DLP method.

In some embodiments, the material the 3D printed part is fabricated from is a radiation-curable silicon composition. According to preferred embodiments, said material is a radiation-curable silicone composition, as described above.

According to certain embodiments, the liquid is in the form of a composition, comprising two or more compounds. According to other embodiments, the liquid is a single liquid compound. For instance, a liquid in the context of the present invention may be comprised of only one substance or of two or more substances, and may or may not contain additional ingredients such, for instance, salts and surfactants, so long as the liquid fulfills the criterion of incompatibility with the material the 3D printed part is formed from, as herein defined.

According to certain other embodiments, the liquid is selected from the group consisting of water and demineralized water.

According to some embodiments, the post processing comprises one or more of cleaning, stabilizing, and post-curing of the three-dimensional part, as defined and described above in the context of the method of the invention. Accordingly, in some embodiments, the cleaning, the stabilizing and/or the post-curing comprises immersing of the three-dimensional part into said liquid. In other embodiments, the cleaning further comprises exposing the immersed three-dimensional part to ultrasound, as described above. In other embodiments, the post-curing further comprises exposing the three-dimensional part to radiation, as described above.

In a method as described herein, as well as by use of a liquid as defined and described herein, gentle cleaning and efficient, thorough post-cure of the 3D printed part, as defined herein, may be accomplished, resulting in a dimensionally stable part featuring a tack-free surface.

It is understood that all embodiments disclosed herein in relation to the compositions, methods, and uses of the invention are similarly applicable to articles formed therefrom/thereby, insofar applicable, and vice versa.

Accordingly, the present invention is also directed to a three-dimensional part obtainable in a method as described herein.

The following examples are given to illustrate the present invention. Because these examples are given for illustrative purposes only, the invention should not be deemed limited thereto.

### EXAMPLES

### Example 1: Cleaning Comparison

Cleaning Methods

1) Printed part: Matrix; taken out of SLA liquid and allowed to drip dried before post-cure for 20to 30 minutes.

2) Printed part: Rook 1; taken out of SLA liquid and drip dried, cleaned by exposure to ultrasound in a water bath for 2 minutes before post-cure in water.

3) Printed part: Rook 2; taken out of SLA liquid and drip dried, cleaned by exposure to ultrasound in a water bath for 10 minutes before post-cure in water.

4) Printed part: Rook 3; taken out of SLA liquid and drip dried, cleaned by exposure to ultrasound in a water bath for 18 minutes before post-cure in water.

Results

1) Drip drying allowed most of SLA silicone uncured material to come off, however, some residual material remains.

2) Rook 1, better surface, but two small windows could not be opened, as residual silicone was present in gaps of the structure during post-cure.

3) Rook 2, improved appearance, one of two small windows is open.

4) Rook 3, both windows are open.

As evident from the above examples, cleaning of the printed part by exposure to ultrasound while submerged in water improves overall appearance, functionality, and level of detail veracity.

### Example 2: Post-Cure Comparison

TABLE 1

| | | Post processing | |
|---|---|---|---|
| Sample | Structure | cleaning | Post-cure conditions |
| Control A | ASTM sheet | — | UVALOC 60 sec/side |
| (Lg UVA) | (SP-2B), big | | at 100 mW/cm² (UVA) |
| | dog bones | | |
| Control B | ASTM sheet | — | UVALOC 60 sec/side |
| (Lg UVV) | (SP-2B), big | | at 120 mW/cm² (UVV) |
| | dog bones | | |
| Control C | ASTM sheet | — | UVALOC 60 sec/side |
| (small) | (SP-2B), big | | at 100 mW/cm² (UVA) |
| | dog bones | | |
| Printed | AS Printed | liquid wiped off, part | — |
| with BL | PR-10 Sheet | removed from platform | |
| | | with burn-layer (BL) | |
| | | left on | |
| Printed | AS Printed | liquid wiped off, | — |
| without | PR-10 Sheet | removedfrom platform | |
| BL | | and burn layer peeled | |
| | | off | |
| Printed/ | AS Printed | liquid wiped off, part | EQ CL-36 LED Cure |
| Post | PR-10 Sheet | removed from platform | Chamber; 405 nm; 7 |
| cured | | with burn-layer (BL) | minutes in water |
| with BL | | left on | |
| Printed/ | AS Printed | liquid wiped off, | EQ CL-36 LED Cure |
| Post cured | PR-10 Sheet | removed from platform | Chamber; 405 nm; 7 |
| without | | and burn layer peeled | minutes in water |
| BL | | off | |

TABLE 2

| | Tensile | Tensile | | |
|---|---|---|---|---|
| | Strength | Strength | | |
| | Blue | Red | | |
| | Modulus | Modulus | Elongation | Hardness |
| Sample | [N/mm²] | [N/mm²] | [%] | Shore A |
| Control A | 3.94 | 2.27 | 173.87 | 50 |
| Control B | 3.96 | 2.26 | 178.96 | 49 |
| Control C | 3.98 | 2.05 | 186.26 | 49 |
| Printed with BL | 2.71 | 1.76 | 169.68 | 42 |
| Printed without BL | 1.92 | 1.41 | 163.89 | 38 |
| Printed/Post cured | 3.65 | 2.78 | 191.37 | 53 |
| with BL | | | | |
| Printed/Post cured | 3.77 | 2.88 | 190.44 | 50 |
| without BL | | | | |

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. The words “comprises/comprising” and the words “having/including” when used herein with reference to the present invention are used to specify the presence of stated features, integers, steps or components but does not preclude the presence or addition of one or more other features, integers, steps, components or groups thereof.

What is claimed is:

1. Method for post processing a 3D printed part, the method comprising:
A) providing a 3D printed part;
B) immersing said part into a first liquid medium that is incompatible with the material said part is printed from, and
C) exposing said part to ultrasound.

2. The method according to claim 1, wherein the 3D printed part is fabricated in an SLA and/or a DLP method; and/or step B) and/or step C) are repeated one or more times.

3. The method according to claim 1, further comprising a step D) of immersing the 3D printed part obtained after step C) into a second liquid medium that is incompatible with the material said part is formed from, and exposing said part to radiation.

4. The method according to claim 1, wherein the first and/or the second liquid medium is selected from the group consisting of water and demineralized water.

5. The method according to claim 1, wherein
step C) is carried out over a period of about 1 second to about 5 hours; and/or
the exposing of step D) is carried out over a period of about 1 second to about 24 hours.

6. The method according to claim 1, wherein
in step A), the 3D printed part is immersed partially or completely; and/or
in step C), ultrasound is applied at frequencies of about 15 kHz to about 40 kHz; and/or
in step D), the radiation is UV light or visible light.

7. The method according to claim 1, the method further comprising a step A1) of removing excess unpolymerized resin material by one or more of drip drying, manual cleaning, and application of air pressure.

8. The method according to claim 1, wherein the material the 3D printed part is printed from is a radiation-curable silicone composition.

9. The method according to claim 8, wherein the radiation-curable silicone composition comprises one or more additives selected from the group consisting of stabilizers, inhibitors, chelating agents, antioxidants, thickeners, plasticizers, fillers, dispersion stabilizers, hindered amine light stabilizers, UV absorbers, opacifiers, pigments, and dyes.

10. A three-dimensional part obtainable in a method according to claim 1.
